(19) United States
(12) Patent Application Publication
(10) Pub. No.: US 2015/0192825 A1
(43) Pub. Date: Jul. 9, 2015

(54) LIQUID CRYSTAL PANEL AND METHOD FOR MANUFACTURING THE SAME

(71) Applicant: Shenzhen China Star Optoelectronics Technology Co., Ltd., Shenzhen (CN)

(72) Inventors: Zan Yang, Shenzhen (CN); Chia-Chiang Hsiao, Shenzhen (CN); Chih-Wen Chen, Shenzhen (CN)

(21) Appl. No.: 13/704,638

(22) PCT Filed: Oct. 18, 2012
(86) PCT No.: PCT/CN2012/083121

§ 371 Date: Sep. 8, 2014

(30) Foreign Application Priority Data
Sep. 25, 2012 (CN) 201210359610.1

(51) Int. Cl. G02F 1/1335; G02B 27/26; G02F 1/1341; G02F 1/13363; G02F 1/1339

(52) U.S. Cl. CPC G02F 1/133512; G02F 1/133516; G02F 1/133528; G02F 1/13363; G02F 1/1339; G02F 1/1341; G02B 27/26; G02F 2001/133354

(57) ABSTRACT

The present invention relates to a liquid crystal panel and method for manufacturing the same. The liquid crystal panel manufacturing method comprises steps of: manufacturing an array substrate and a color filter substrate, sealing the array substrate and the color filter substrate together, and injecting liquid crystal material therebetween so as to form a liquid crystal cell, the color filter substrate having a first black matrix and a color resistor layer at an inner side thereof; and forming a second black matrix on an external surface of the color filter substrate by ink-jet printing. The liquid crystal panel and method for manufacturing the same is quite simple, the production efficiency is improved, and the manufacturing cost is reduced.

### BACKGROUND OF THE INVENTION

1. Field of the Invention

The present invention relates to a liquid crystal display technology, and more particularly, to a liquid crystal panel and method for manufacturing the same.

2. Description of Prior Art

Nowadays, liquid crystal displays (LCDs) have been widely used in displaying 3D images. For example, a 3D liquid crystal display equipped with a film-type patterned retarder (FPR) is developed. In the 3D liquid crystal panel, 3D viewing angle is an important indication, which represents a range of angles a viewer at a certain distance is able to see the 3D images.

The 3D viewing angle can be improved by increasing the size of a black matrix (BM) in a color filter substrate of the liquid crystal panel. However, this approach is merely suitable for large-scale liquid crystal panels. If the liquid crystal panel is relatively small in size, increasing the size of BM may result in dramatic decrease of an aperture ratio.

In conventional skills, the black matrix will be disposed at both sides of the color filter substrate. In such a manner, the 3D viewing angle of the 3D liquid crystal panel can be greatly improved at the cost of decreasing a small amount of the aperture ratio. FIG. 1 is a schematic structural diagram showing a conventional liquid crystal panel used in a 3D liquid crystal display. As shown in FIG. 1, the reference number 11 denotes a thin-film transistor array substrate, 12 denotes a color filter substrate, 121 denotes a color resistor layer, 122 denotes a first black matrix, 123 denotes a glass substrate, and 124 denotes a second black matrix. As shown in FIG. 1, the 3D viewing angle is θ when the second black matrix 124 is not presented. That is, the 3D images can be seen within the angle θ. On the other hand, the 3D viewing angle is θ′ when the second black matrix 124 is presented. That is, the 3D images can be seen within the angle θ′. The viewing angle for seeing the 3D images normally is enlarged since the arrangement of the second black matrix 124 eliminates image interference that may be occurred in the displaying process.

The method for manufacturing the first black matrix 122 and the second black matrix 124 of the color filter substrate shown in FIG. 1 is similar to that of the color resistor layer 121. All of them are manufactured by coating a photoresist, and then performing a photolithographic process and a developing process so as to form a pattern of a mask. Adopting the similar approach to manufacturing the first black matrix 122, the second black matrix 123 and the color resistor layer 121 can alleviate the situation of low production yield resulted from different manufacturing ways. However, using the afore-described approach to manufacturing the first black matrix 122 and the second black matrix 124 takes more time and the manufacturing cost is relatively high. To a certain extent, this will reduce the production efficiency of the liquid crystal panel and increase the manufacturing cost.

Therefore, it is necessary to provide a liquid crystal panel and method for manufacturing the same for solving the conventional technical problems.

### SUMMARY OF THE INVENTION

An objective of the present invention is to provide a liquid crystal panel and method for manufacturing the same capable of simplifying the manufacturing process, increasing the production efficiency, and reducing the manufacturing cost, solving the technical problems including complicated processes, low production efficiency, and high manufacturing cost caused in conventional liquid crystal panels.

To solve above problems, the present invention provides technical schemes as below.

The present invention relates to a method for manufacturing a liquid crystal panel, which comprises steps of: manufacturing an array substrate and a color filter substrate, sealing the array substrate and the color filter substrate together, and injecting liquid crystal material therebetween so as to form a liquid crystal cell, the color filter substrate having a first black matrix and a color resistor layer at an inner side thereof; forming a second black matrix on an external surface of the color filter substrate by ink-jet printing; and filling isotropic material into voids of the second black matrix for securing the second black matrix; wherein the step of forming the second black matrix on the external surface of the color filter substrate by ink-jet printing comprises: utilizing a spray nozzle for disposing the second black matrix on the external surface of the color filter substrate and aligning the second black matrix with the first black matrix of the color filter substrate.

In the liquid crystal panel manufacturing method of the present invention, said method further comprises: disposing a polarizing film on an external surface of the second black matrix; and disposing a patterned phase retarder film on an external surface of the polarizing film.

The present invention further relates to a method for manufacturing a liquid crystal panel, which comprises steps of: manufacturing an array substrate and a color filter substrate, sealing the array substrate and the color filter substrate together, and injecting liquid crystal material therebetween so as to form a liquid crystal cell, the color filter substrate having a first black matrix and a color resistor layer at an inner side thereof; and attaching a film structure to an external surface of the color filter substrate, wherein the film structure has a first adhering layer and a second black matrix, the color filter substrate adheres to one side of the first adhering layer as well as the second black matrix adheres to the other side of the first adhering layer.

In the liquid crystal panel manufacturing method of the present invention, said method further comprises: aligning the second black matrix of the film structure with the first black matrix of the color filter substrate.

In the liquid crystal panel manufacturing method of the present invention, said method further comprises: filling isotropic material into voids of the second black matrix for securing the second black matrix.

In the liquid crystal panel manufacturing method of the present invention, the film structure further comprises a triacetyl cellulose (TAC) film, which is disposed at a side opposite to the side where the second black matrix contacts the first adhering layer, and said method further comprises: providing a polarizing film and a patterned phase retarder film; disposing the polarizing film on an external surface of the TAC film of the film structure; and disposing the patterned phase retarder film on an external surface of the polarizing film.

In the liquid crystal panel manufacturing method of the present invention, the film structure further comprises a second adhering film, which is disposed at a side opposite to the side where the second black matrix contacts the first adhering layer, and said method further comprises: providing a polarizing film and a patterned phase retarder film; attaching the polarizing film to the second adhering film of the film structure; and disposing the patterned phase retarder film on an external surface of the polarizing film.

The present invention further relates to a liquid crystal panel, which comprises an array substrate; a color filter substrate disposed opposite to the array substrate, the color filter substrate having a first black matrix and a color resistor layer at an inner side thereof; a liquid crystal layer disposed between the array substrate and the color filter substrate; and a film structure attached to an external surface of the color filter substrate; the film structure comprising: a first adhering layer having one side used for adhering the film structure onto the external surface of the color filter substrate; and a second black matrix disposed at the other side of the first adhering layer.

In the liquid crystal panel of the present invention, the film structure further comprises: a triacetyl cellulose (TAC) film disposed at a side opposite to the side where the second black matrix contacts the first adhering layer, the TAC film being utilized for protecting and supporting the second black matrix.

In the liquid crystal panel of the present invention, the second black matrix and the TAC film have a second adhering film disposed therebetween, the second adhering film being utilized for being convenient to peel off the TAC film.

In the liquid crystal panel of the present invention, the film structure further comprises isotropic material for filling into voids of the second black matrix for securing the second black matrix.

In the liquid crystal panel of the present invention, the liquid crystal panel further comprises: a polarizing film attached to an external surface of the film structure; and a patterned phase retarder film disposed on an external surface of the polarizing film.

Compared to a conventional liquid crystal panel, the liquid crystal panel and method of manufacturing the same in the present invention is quite simple, the production efficiency is improved, and the manufacturing cost is reduced. Therefore, the present invention can solve the technical problems including complicated processes, low production efficiency, and high manufacturing cost caused in conventional liquid crystal panels.

To make above content of the present invention more easily understood, it will be described in details by using preferred embodiments in conjunction with the appending drawings.

### BRIEF DESCRIPTION OF THE DRAWINGS

FIG. 1 is a schematic structural diagram showing a conventional liquid crystal panel used in a 3D liquid crystal display.

FIG. 2 is a flow chart of a method for manufacturing a liquid crystal panel according to a first preferable embodiment of the present invention.

FIG. 3 is a schematic structural diagram showing the liquid crystal panel manufacturing method according to the first preferable embodiment of the present invention.

FIG. 4 is a flow chart of a method for manufacturing a liquid crystal panel according to a second preferable embodiment of the present invention.

FIG. 5 is a schematic structural diagram showing the liquid crystal panel manufacturing method according to the second preferable embodiment of the present invention.

FIG. 6 is a flow chart of a method for manufacturing a liquid crystal panel according to a third preferable embodiment of the present invention.

FIG. 7 is a flow chart of a method for manufacturing a liquid crystal panel according to a fourth preferable embodiment of the present invention.

FIG. 8 is a schematic structural diagram showing a liquid crystal panel according to a first preferable embodiment of the present invention.

FIG. 9 is a schematic structural diagram showing a liquid crystal panel according to a second preferable embodiment of the present invention.

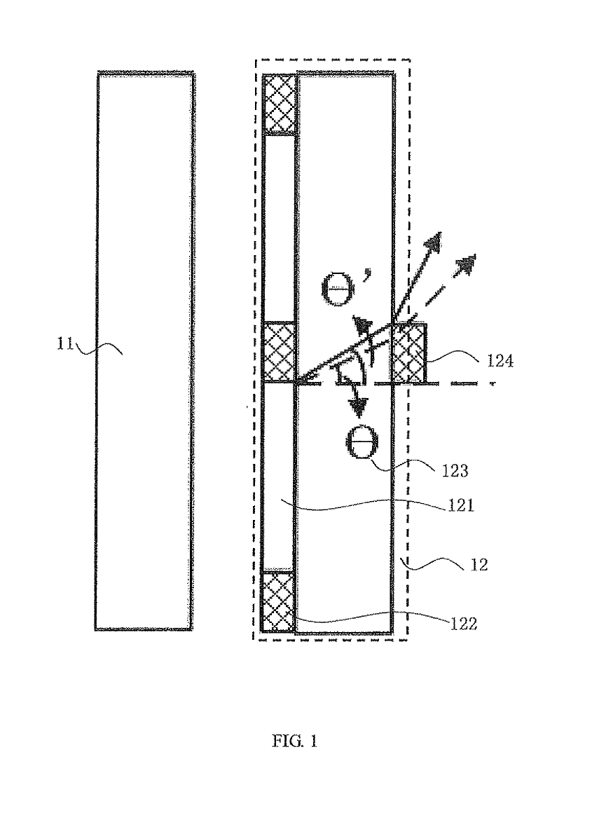

### DETAILED DESCRIPTION OF THE PREFERRED EMBODIMENTS

The following descriptions for the respective embodiments are specific embodiments capable of being implemented for illustrations of the present invention with referring to appended figures. In the descriptions of the present invention, spatially relative terms, such as “upper”, “lower”, “front”, “back”, “left”, “right”, “inner”, “outer”, “lateral”, and the like, may be used herein for ease of description as illustrated in the figures. Therefore, it will be understood that the spatially relative terms are intended to illustrate for understanding the present invention, but not to limit the present invention.

In the appending drawings, units having similar structures are labeled by the same reference numbers.

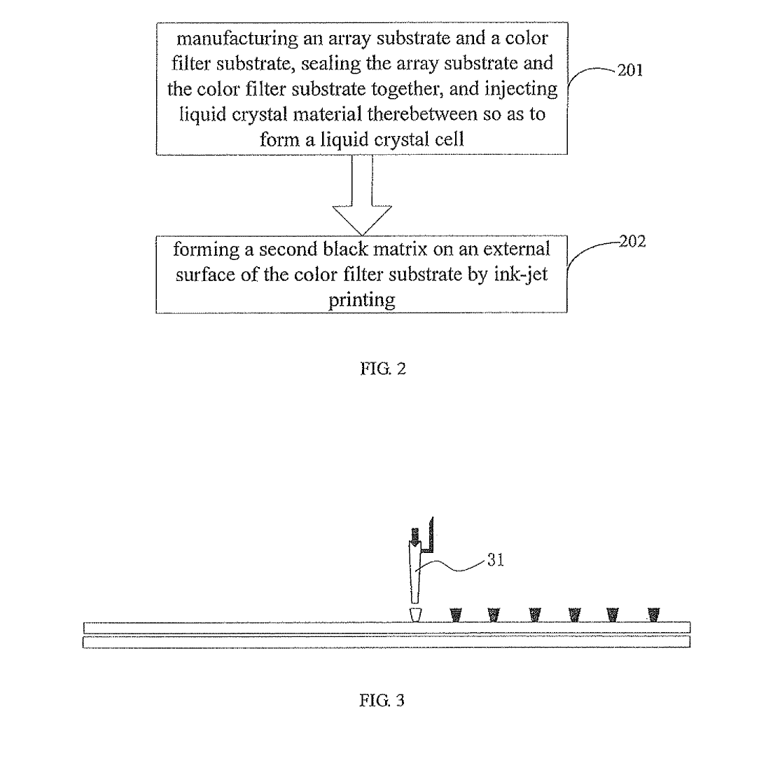

Please refer to FIG. 2 and FIG. 3. FIG. 2 is a flow chart of a method for manufacturing a liquid crystal panel according to a first preferable embodiment of the present invention. FIG. 3 is a schematic structural diagram showing the liquid crystal panel manufacturing method according to the first preferable embodiment of the present invention. The liquid crystal panel manufacturing method comprises following steps.

Step 201: an array substrate and a color filter substrate are manufactured. Then, the array substrate and the color filter substrate are sealed together and liquid crystal material is injected therebetween so as to form a liquid crystal cell.

Step 202: a second black matrix is formed on an external surface of the color filter substrate by ink-jet printing.

The liquid crystal panel manufacturing method is finished after Step 202.

In concrete implementations, the liquid crystal panel manufacturing method of the preset preferable embodiment is detailed below.

In Step 201, manufacturing the array substrate and the color filter substrate, sealing the array substrate and the color filter substrate together, and injecting the liquid crystal material therebetween are proceeded so as to form the liquid crystal cell, wherein the color filter substrate has a first black matrix and a color resistor layer at an inner side thereof.

In Step 202, a spray nozzle 31 is utilized to perform ink-jet printing at regular intervals on the external surface of the color filter substrate such the second black matrix is disposed on the external surface of the color filter substrate. At the same time, the second black matrix is aligned to the first black matrix of the color filter substrate. Then, isotropic material is filled into voids of the second black matrix for fastening or securing the second black matrix.

If the liquid crystal panel is to be manufactured as a 3D display panel, a polarizing film and a patterned phase retarder film may be attached to the liquid crystal panel as well. The polarizing film is disposed on an external surface of the second black matrix. The polarizing film is utilized for forming linearly polarized light rays and may be implemented by a poly vinyl alcohol (PVA) film, for example. The patterned phase retarder film is disposed on an external surface of the polarizing film. By utilizing the pattern on the phase retarder film, left-handed circularly polarized light and right-handed circularly polarized light can be generated. One of a user's eyes receives the left-handed circularly polarized light and the other eye receives the right-handed circularly polarized light by using a polarizing eyeglasses. In such a manner, the user can perceive three-dimensional images through the eyes.

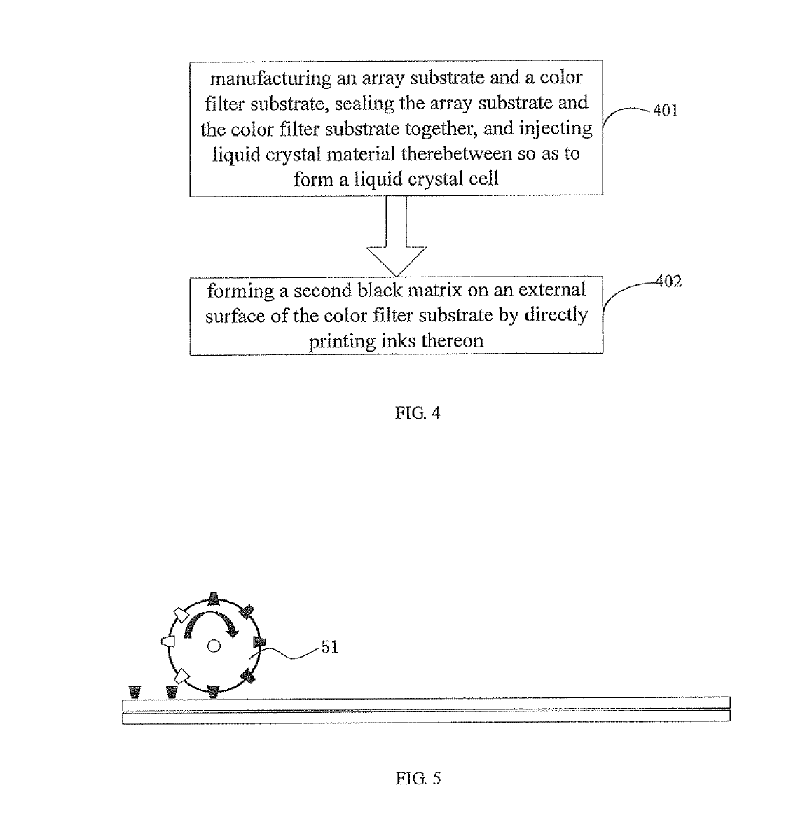

Please refer to FIG. 4 and FIG. 5. FIG. 4 is a flow chart of a method for manufacturing a liquid crystal panel according to a second preferable embodiment of the present invention. FIG. 5 is a schematic structural diagram showing the liquid crystal panel manufacturing method according to the second preferable embodiment of the present invention. The liquid crystal panel manufacturing method comprises following steps.

Step 401: an array substrate and a color filter substrate are manufactured. Then, the array substrate and the color filter substrate are sealed together and liquid crystal material is injected therebetween so as to form a liquid crystal cell.

Step 402: a second black matrix is formed on an external surface of the color filter substrate by directly printing inks thereon.

In concrete implementations, the liquid crystal panel manufacturing method of the preset preferable embodiment is detailed below.

In Step 401, manufacturing the array substrate and the color filter substrate, sealing the array substrate and the color filter substrate together, and injecting the liquid crystal material therebetween are proceeded so as to form the liquid crystal cell, wherein the color filter substrate has a first black matrix and a color resistor layer at an inner side thereof.

In Step 402, the second black matrix is firstly disposed on an external surface of a cylinder 51 at regular intervals. Specifically, a printing device having a concave pattern is utilized to print black ink on the external surface of the cylinder 51. Then, the black ink is transferred to the external surface of the color filter substrate by the cylinder 51. At the same time, the second black matrix is aligned to the first black matrix of the color filter substrate. Then, isotropic material is filled into voids of the second black matrix for fastening or securing the second black matrix.

If the liquid crystal panel is to be manufactured as a 3D display panel, a polarizing film and a patterned phase retarder film may be attached to the liquid crystal panel as well. The polarizing film is disposed on an external surface of the second black matrix. The polarizing film is utilized for forming linearly polarized light rays and may be implemented by a poly vinyl alcohol (PVA) film, for example. The patterned phase retarder film is disposed on an external surface of the polarizing film. By utilizing the pattern on the phase retarder film, left-handed circularly polarized light and right-handed circularly polarized light can be generated. One of a user's eyes receives the left-handed circularly polarized light and the other eye receives the right-handed circularly polarized light by using a polarizing eyeglasses. In such a manner, the user can perceive three-dimensional images through the eyes.

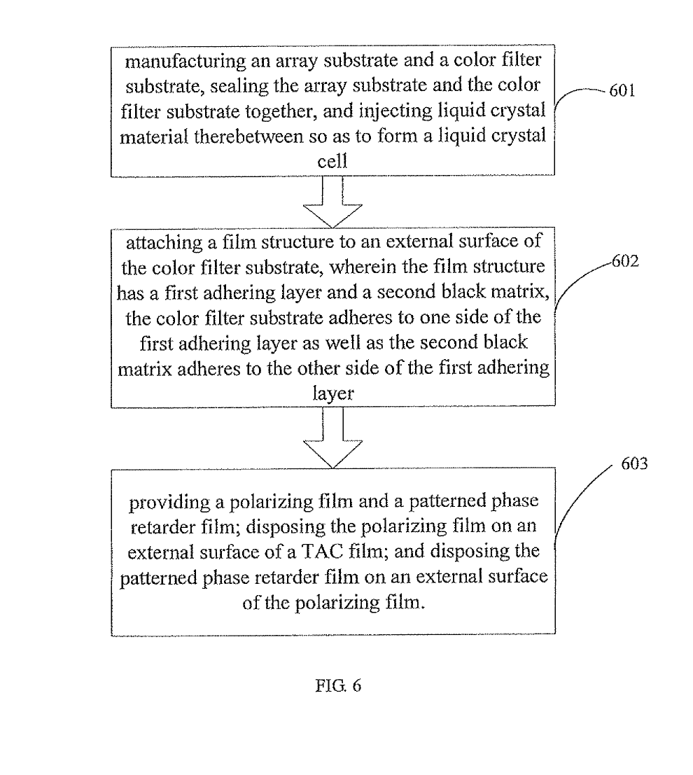

Please refer to FIG. 6, which is a flow chart of a method for manufacturing a liquid crystal panel according to a third preferable embodiment of the present invention. The liquid crystal panel comprises an array substrate, a color filter substrate, and a liquid crystal layer disposed between the array substrate and the color filter substrate. The color filter substrate has a first black matrix and a color resistor layer at an inner side thereof. In addition, a film structure comprises a first adhering layer, a second black matrix, a triacetyl cellulose (TAC) film, and a protection layer. The first adhering layer has one side that is used for adhering the film structure onto the external surface of the color filter substrate. The second black matrix is disposed at the other side of the first adhering layer. The first adhering layer has the protection layer attached thereon for protecting the first adhering layer. The TAC film is utilized for protecting and supporting the second black matrix of the film structure. The TAC film is disposed at a side opposite to the side where the second black matrix contacts the first adhering layer. That is, the second black matrix is disposed between the TAC film and the first adhering layer. The film structure further comprises isotropic material for filling into voids of the second black matrix for fastening or securing the second black matrix.

The liquid crystal panel manufacturing method is described as below.

Step 601: manufacturing the array substrate and the color filter substrate, sealing the array substrate and the color filter substrate together, and injecting the liquid crystal material therebetween are proceeded so as to form the liquid crystal cell.

Step 602: the film structure is attached to the external surface of the color filter substrate. The film structure has the first adhering layer and the second black matrix. The first adhering layer is adhered onto the color filter substrate at one side thereof and is adhered onto the second black matrix at the other side thereof. In addition, it needs to align the second black matrix of the film structure to the first black matrix of the color filter substrate when attaching the film structure to the external surface of the color filter substrate.

Step 603: a polarizing film and a patterned phase retarder film are provided. The polarizing film is disposed on an external surface of the TAC film. The patterned phase retarder film is disposed on an external surface of the polarizing film.

After the array substrate and the color filter substrate of the liquid crystal panel are sealed together, the film structure is attached to the external surface of the color filter substrate by utilizing the first adhering layer and then the polarizing film and the patterned phase retarder film are sequentially attached to the TAC film of the film structure. In such a manner, the manufacture for the liquid crystal panel is finished. The manufacturing process for the liquid crystal panel of a 3D liquid crystal display is quite simple, the production efficiency is improved, and the manufacturing cost is reduced.

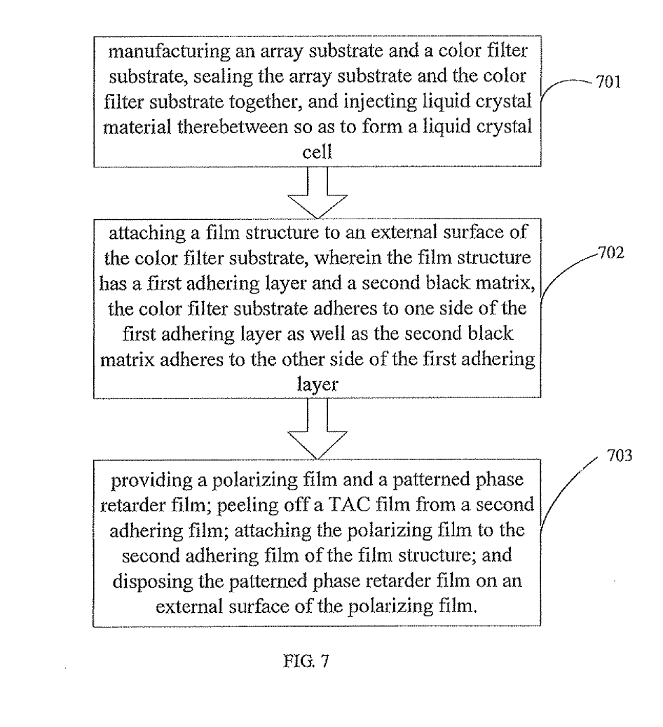

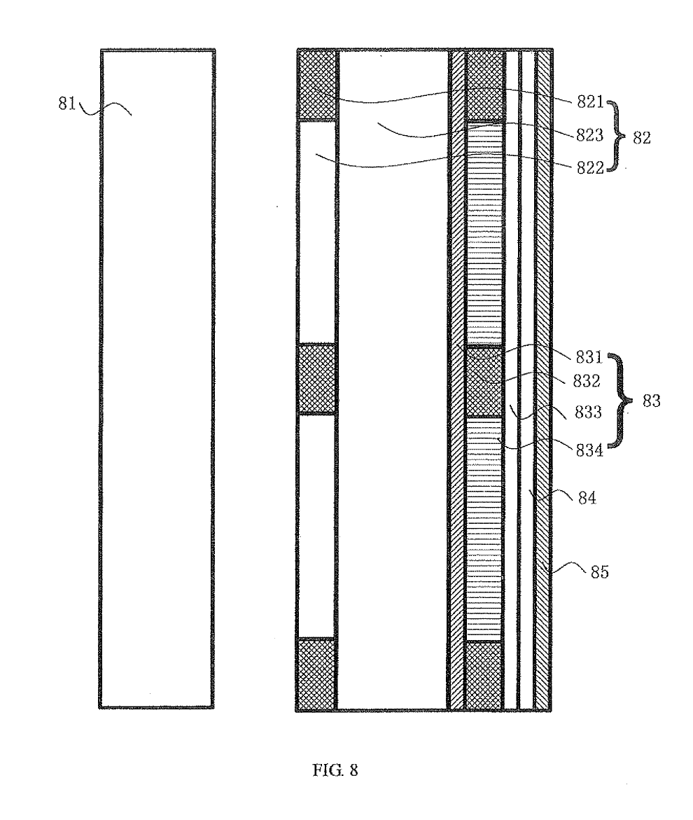

Please refer to FIG. 7, which is a flow chart of a method for manufacturing a liquid crystal panel according to a fourth preferable embodiment of the present invention. The difference between the fourth preferable embodiment and the third preferable embodiment is that in the fourth preferable embodiment, the film structure further comprises a second adhering layer and the second black matrix is fastened to the TAC film via the second adhering layer. When it is going to attach the polarizing film and the patterned phase retarder film, the TAC film may be peeled off or removed from the second adhering film. Then, the polarizing film is fastened onto the film structure via the second adhering film. Accordingly, the thickness of the whole liquid crystal panel can be decreased and the displaying effect for 3D images is improved.

The liquid crystal panel manufacturing method is described as below.

Step 701: manufacturing the array substrate and the color filter substrate, sealing the array substrate and the color filter substrate together, and injecting the liquid crystal material therebetween are proceeded so as to form the liquid crystal cell.

Step 702: the film structure is attached to the external surface of the color filter substrate. The film structure has the first adhering layer and the second black matrix. The first adhering layer is adhered onto the color filter substrate at one side thereof and is adhered onto the second black matrix at the other side thereof. In addition, it needs to align the second black matrix of the film structure to the first black matrix of the color filter substrate when attaching the film structure to the external surface of the color filter substrate.

Step 703: a polarizing film and a patterned phase retarder film are provided. The TAC film is peeled off or removed from the second adhering film. The polarizing film is adhered to the second adhering film of the film structure. The patterned phase retarder film is disposed on an external surface of the polarizing film.

In the present embodiment, after attaching the film structure onto the external surface of the color filter substrate, the TAC film of the film structure is peeled off and then the polarizing film and the patterned phase retarder film are sequentially attached to the second adhering layer. In such a manner, the manufacture for the liquid crystal panel is finished. This approach can reduce the thickness of a layer on the external surface of the color filter substrate and improve the displaying effect of 3D images.

It is noted that the step of peeling off the TAC film from the second adhering layer may be omitted if the film structure does not have the TAC film. Instead, the polarizing film may be directly attached to the second adhering film as well.

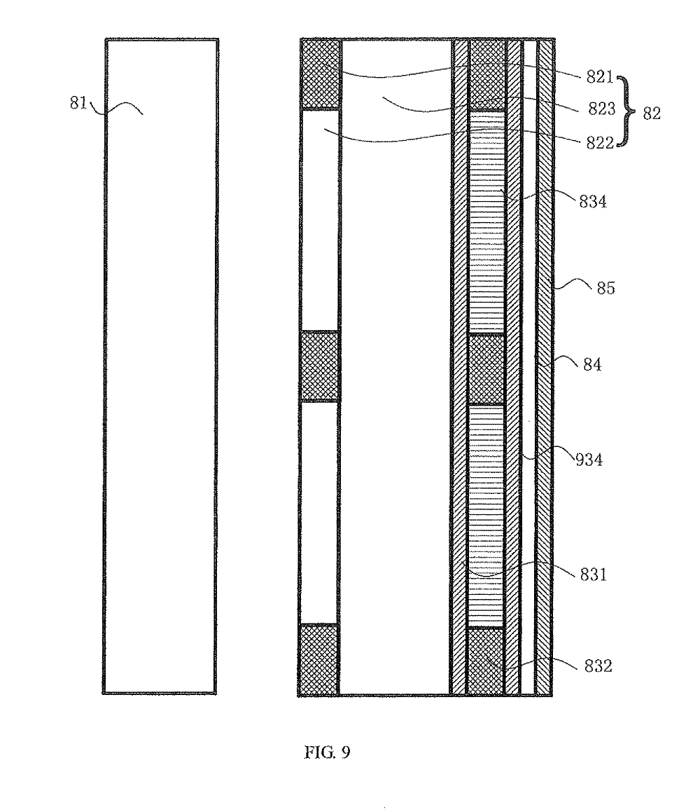

The present invention also relates to a liquid crystal panel. Please refer to FIG. 8, which is a schematic structural diagram showing a liquid crystal panel according to a first preferable embodiment of the present invention. The liquid crystal panel comprises an array substrate 81, a color filter substrate 82 disposed opposite to the array substrate 81, and a liquid crystal layer (not shown) disposed between the array substrate 81 and the color filter substrate 82. The color filter substrate 82 comprises a first black matrix 821, a color resistor layer 822, and a glass substrate 823. The liquid crystal panel further has a film structure 83 attached onto an external surface of the color filter substrate 82. The liquid crystal panel, serving as a 3D display panel, also has a polarizing film 84 and a patterned retarder film 85 attached thereto. The film structure 83 is utilized to form a second black matrix 832 on the external surface of the color filter substrate 82. The polarizing film 84 is disposed on an external surface of the film structure 83 and may be implemented by a poly vinyl alcohol (PVA) film, for example. The polarizing film is utilized for forming linearly polarized light rays. The patterned phase retarder film 85 is disposed on an external surface of the polarizing film 84. By utilizing the pattern on the phase retarder film 85, left-handed circularly polarized light and right-handed circularly polarized light can be generated. One of a user's eyes receives the left-handed circularly polarized light and the other eye receives the right-handed circularly polarized light by using a polarizing eyeglasses. In such a manner, the user can perceive three-dimensional images through the eyes.

The film structure 83 comprises a first adhering layer 831, the second black matrix 832, and a triacetyl cellulose (TAC) film 833. The first adhering layer 831 has one side that is used for adhering the film structure 83 onto the external surface of the color filter substrate. The second black matrix 832 is disposed at the other side of the first adhering layer 831. The TAC film 833 is utilized for protecting and supporting the second black matrix 832 of the film structure 83. The TAC film 833 is disposed at a side opposite to the side where the second black matrix 832 contacts the first adhering layer 831. That is, the second black matrix 832 is disposed between the TAC film 833 and the first adhering layer 831. The film structure 83 further comprises isotropic material 834 for filling into voids of the second black matrix 832 for fastening or securing the second black matrix 832.

In the liquid crystal panel of the present embodiment, the light rays emitted from the film structure 83 are polarized by the polarizing film 84 so as to form linearly polarized light. Then, the linearly polarized light is transformed into left-handed or right-handed circularly polarized light by the patterned phase retarder film 85. In such a manner, a user can perceive three-dimensional images through the eyes.

The detailed usage of the liquid crystal panel of the present embodiment is similar to or the same as the above described liquid crystal panel manufacturing method of the third preferable embodiment, and therefore please refer to the liquid crystal panel manufacturing method of the third preferable embodiment.

Please refer to FIG. 9, which is a schematic structural diagram showing a liquid crystal panel according to a second preferable embodiment of the present invention. The difference between the liquid crystal panel of the second preferable embodiment and the first preferable embodiment is that in the liquid crystal panel of the second preferable embodiment, the film structure 83 further comprises a second adhering layer 934 and the second black matrix 832 is fastened to the TAC film 833 via the second adhering layer 834. When it is going to attach the polarizing film 84 and the patterned phase retarder film 85, the TAC film 833 may be peeled off or removed from the second adhering film 934. Then, the polarizing film 84 is fastened onto the film structure 83 via the second adhering film 934. Accordingly, the thickness of the whole liquid crystal panel can be decreased and the displaying effect for 3D images is improved.

The detailed usage of the liquid crystal panel of the present embodiment is similar to or the same as the above described liquid crystal panel manufacturing method of the fourth preferable embodiment, and therefore please refer to the liquid crystal panel manufacturing method of the fourth preferable embodiment.

The liquid crystal panel and method of manufacturing the same is quite simple, the production efficiency is improved, and the manufacturing cost is reduced. Therefore, the present invention can solve the technical problems including complicated processes, low production efficiency, and high manufacturing cost caused in conventional liquid crystal panels.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A method for manufacturing a liquid crystal panel, comprising steps of:
manufacturing an array substrate and a color filter substrate, sealing the array substrate and the color filter substrate together, and injecting liquid crystal material therebetween so as to form a liquid crystal cell, the color filter substrate having a first black matrix and a color resistor layer at an inner side thereof;
forming a second black matrix on an external surface of the color filter substrate by ink jet printing; and
filling isotropic material into voids of the second black matrix for securing the second black matrix;
wherein the step of forming the second black matrix on the external surface of the color filter substrate by ink-jet printing comprises:
utilizing a spray nozzle for disposing the second black matrix on the external surface of the color filter substrate and aligning the second black matrix with the first black matrix of the color filter substrate.

2. The method according to claim 1, further comprising:
disposing a polarizing film on an external surface of the second black matrix; and
disposing a patterned phase retarder film on an external surface of the polarizing film.

3. A method for manufacturing a liquid crystal panel, comprising steps of:
manufacturing an array substrate and a color filter substrate, sealing the array substrate and the color filter substrate together, and injecting liquid crystal material therebetween so as to form a liquid crystal cell, the color filter substrate having a first black matrix and a color resistor layer at an inner side thereof; and
attaching a film structure to an external surface of the color filter substrate, wherein the film structure has a first adhering layer and a second black matrix, the color filter substrate adheres to one side of the first adhering layer as well as the second black matrix adheres to the other side of the first adhering layer.

4. The method according to claim 3, further comprising:
aligning the second black matrix of the film structure with the first black matrix of the color filter substrate.

5. The method according to claim 3, further comprising:
filling isotropic material into voids of the second black matrix for securing the second black matrix.

6. The method according to claim 3, wherein the film structure further comprises a triacetyl cellulose (TAC) film, which is disposed at a side opposite to the side where the second black matrix contacts the first adhering layer, and said method further comprises:
providing a polarizing film and a patterned phase retarder film;
disposing the polarizing film on an external surface of the TAC film of the film structure; and
disposing the patterned phase retarder film on an external surface of the polarizing film.

7. The method according to claim 3, wherein the film structure further comprises a second adhering film, which is disposed at a side opposite to the side where the second black matrix contacts the first adhering layer, and said method further comprises:
providing a polarizing film and a patterned phase retarder film;
attaching the polarizing film to the second adhering film of the film structure; and
disposing the patterned phase retarder film on an external surface of the polarizing film.

8. A liquid crystal panel, comprising:
an array substrate;
a color filter substrate disposed opposite to the array substrate, the color filter substrate having a first black matrix and a color resistor layer at an inner side thereof;
a liquid crystal layer disposed between the array substrate and the color filter substrate; and
a film structure attached to an external surface of the color filter substrate;
the film structure comprising:
a first adhering layer having one side used for adhering the film structure onto the external surface of the color filter substrate; and
a second black matrix disposed at the other side of the first adhering layer.

9. The liquid crystal panel according to claim 8, wherein the film structure further comprises:
a triacetyl cellulose (TAC) film disposed at a side opposite to the side where the second black matrix contacts the first adhering layer, the TAC film being utilized for protecting and supporting the second black matrix.

10. The liquid crystal panel according to claim 9, wherein the second black matrix and the TAC film have a second adhering film disposed therebetween, the second adhering film being utilized for being convenient to peel off the TAC film.

11. The liquid crystal panel according to claim 8, wherein the film structure further comprises isotropic material for filling into voids of the second black matrix for securing the second black matrix.

12. The liquid crystal panel according to claim 8, further comprising:
a polarizing film attached to an external surface of the film structure; and
a patterned phase retarder film disposed on an external surface of the polarizing film.
